(19) United States
(12) Patent Application Publication
(10) Pub. No.: US 2003/0019344 A1
(43) Pub. Date: Jan. 30, 2003

(54) Metal perforating stencil, method for its production and use of the perforating stencil

(76) Inventors: Peter Leerkamp, Boxmeer (NL); Cornelis Johannes Jeckmans, Boxmeer (NL)

Correspondence Address: OSTROLENK FABER GERB & SOFFEN, 1180 AVENUE OF THE AMERICAS, NEW YORK, NY, 100368403

(21) Appl. No.: 10/153,479

(22) Filed: May 22, 2002

Related U.S. Application Data
(63) Continuation of application No. PCT/NL01/00243, filed on Mar. 26, 2001.

(30) Foreign Application Priority Data
Mar. 28, 2000 (NL) 1014769

(51) Int. Cl. B26F 1/06; B21K 5/20; B32B 31/00

(52) U.S. Cl. 83/669; 83/867; 76/107.1; 216/56

(57) ABSTRACT

A metal perforating stencil for use in making perforations in a film under vacuum comprises a metal support in which there are continuous openings which are separated by dykes. In this stencil, the ratio of the thickness of the stencil with respect to the maximum radius of an opening on the active side of the stencil is greater than 1.15. If desired, at least the active side of the stencil may be provided with a rough surface structure which is deposited by electrodeposition means. A stencil of this type has improved release properties, resulting in a long service life, which also has a beneficial effect on the production rate and the quality of the perforated film which is obtained using the stencil.

### CROSS-REFERENCE TO RELATED APPLICATION

This is a continuation application of PCT/NL01/00243 filed Mar. 26, 2001, which PCT application claims priority of Dutch patent application number 1014769 filed Mar. 28, 2000, herein incorporated by reference.

### FIELD OF THE INVENTION

The present invention relates firstly to a metal perforating stencil for use in making perforations under vacuum in a plastic film, which stencil comprises a metal support in which there are continuous openings which are separated by dykes.

### BACKGROUND OF THE INVENTION

A metal perforating stencil of this kind is known, for example, from U.S. Pat. No. 4,214,945 and is used for perforating thin plastic films which are used in absorbent articles, such as absorbent objects for personal care, for example diapers. In objects of this type, the permeability of the perforated film is utilized. In the known perforation techniques, a metal perforating stencil is used, generally comprising a thin-walled hollow cylinder as support, in which continuous openings which are separated by dykes are provided. A nickel perforating stencil according to U.S. Pat. No. 4,214,945 can be produced by means of electroforming, in which a layer of metallic nickel is deposited on an aluminium cylinder with an outer surface which is provided with a large number of projections (for example by means of knurling). After machining of the nickel cylinder which has been deposited in this way, the nickel cylinder is removed from the aluminium cylinder, is severed in the longitudinal direction, is turned inside out and is fixed again by welding.

The perforated plastic films are generally produced by heating a thin film, for example of polyethylene, and passing the film which has been heated in this way over the perforating stencil and sucking the film partially into the stencil by means of a vacuum which is applied to the film through the perforations in the stencil. If the vacuum is high enough, the film is permanently deformed and breaks in the opening in the stencil, with the result that perforations in the film are created at these locations. As an alternative to a heated film, this method can also be carried out using a molten film which is produced from granules.

One of the problems of the method is the poor release of the (heated) film from the stencil, since the film to some extent sticks to the stencil and since a certain degree of mechanical anchoring of the film in the openings of the perforating stencil occurs. On account of this poor release, the perforating method is limited by the rotational speed of the stencil. Furthermore, the service life of the stencil is relatively short on account of the high adhesive forces between the film and the stencil. However, the poor release of the film from the stencil also brings about undesirable properties in the perforated film itself. This is because the unstable film is deformed more than is necessary on account of the relatively long residence time on the stencil, which results, for example in lower permeability of the perforated film.

To promote the release, in practice the perforating stencil is treated with iron chloride in order in this way to effect a slight roughness on the surface of the stencil. However, the results of a treatment of this type are unsatisfactory.

It is an object of the invention to provide a metal perforating stencil for use in making perforations under vacuum in a plastic film, the release properties of which stencil are improved.

It is another object of the present invention to provide a perforating stencil of this type in which the roughness of the surface is relatively great.

It is yet another object of the invention to provide a simple and relatively inexpensive method for producing an improved perforating stencil of this type.

It is yet another object of the invention to improve the quality of the perforated film obtained using the stencil with improved release properties.

### SUMMARY OF THE INVENTION

In a metal perforating stencil of the type described above, according to the invention the ratio of the thickness of the stencil to the maximum radius of a continuous opening on the active side of the stencil is more than 1.15. If the ratio is less than 1.15, it has been found that the film can become fixed underneath the stencil through the openings, with all the adverse consequences of this, including poor release and undesirable deformation. Furthermore, it has been found that counteracting the mechanical anchoring has a much greater influence on the desired improvement of the release properties than increasing the surface roughness (in relative terms 95% against 5%). Furthermore, tests have shown that by improving the release properties according to the invention it is possible to double the service life of the stencil. A perforating stencil according to the invention has a service life of 1000-2000 operating hours, while a perforating stencil with a ratio of 0.90 had a service life of only 500 operating hours.

The present invention also relates to a method for producing a perforating stencil, which stencil comprises a support in which there are continuous openings, which openings are separated by dykes, in which method the stencil is produced in such a manner that the ratio of the thickness of the stencil to the maximum radius of a continuous opening is more than 1.15, so that the advantages discussed above are obtained.

The invention also relates to the use of a perforating stencil according to the invention or a perforating stencil produced with the aid of the method according to the invention for perforating a plastic film under vacuum.

### BRIEF DESCRIPTION OF THE DRAWINGS

The invention is explained below with reference to the following examples and drawing, in which:

FIG. 1 shows a cross section through part of a perforating stencil according to the invention; and

FIG. 2 shows a detail of a rough surface structure of a perforating stencil according to the invention.

### DESCRIPTION OF THE PREFERRED EMBODIMENTS

The perforating stencil is preferably seamless, so that the openings can be situated over the entire circumference. A suitable production method will be discussed in more detail below. Advantageously, at least the active side of the stencil is provided with a rough surface structure which is deposited by electrodeposition.

Unlike the treatment with iron chloride, which has only allowed a slight improvement to the surface roughness, it has been found that when a basic skeleton is coated with a rough surface structure in an electrodeposition bath, the roughness of the stencil obtained is such that the release properties of the perforating stencil are improved still further, which has a beneficial effect on the processing rate, the service life of the stencil and the quality of the perforated film.

The rough surface structure which is obtained by electrodeposition means preferably comprises a covering layer of nickel, a roughening layer of copper and an adhesion layer for promoting the adhesion between the copper roughening layer and the support. In this preferred embodiment of the perforating stencil according to the invention, an adhesion layer, which preferably likewise consists of nickel and to which a roughening layer of copper is applied, is provided on the support, which advantageously comprises a basic metal skeleton, for example of nickel, which is grown further in an electrodeposition bath. This roughening layer imparts an improved roughness to the perforating stencil according to the invention. To prevent excess wear to this relatively soft copper roughening layer, this roughening layer is covered with a protective layer of nickel, which has a high resistance to wear. The thickness of the various layers is dependent, inter alia, on the mesh number, the pattern and the shape of the openings. In general, the perforating stencils according to the invention have a thickness in the range from 350-600 μm, a permeability of approximately 35% and a mesh number in the range from 15-50, for example 18 or 24.

Advantageously, the dykes of the perforating stencil according to the invention do not have any sharp transitions, such as corners or the like, on the active side, but rather there is a gradual transition from the active surface to the inner walls of the openings. This measure reduces the risk of mechanical anchoring still further.

Preferably, in the method according to the invention a basic stencil is produced by means of a two-step electroforming method, in which a basic skeleton is deposited on an electroforming mould with a pattern of insulator regions which are separated by electrical conductors, from an electrodeposition bath, and then the skeleton formed in this way is removed, and the basic skeleton which has been removed is allowed to grow further in a suitable electrodeposition bath to form a seamless perforating stencil. Examples of this technique are described, inter alia, in European Patent Applications EP-A-0 038 104 and EP-A-0 492 731, in the name of the applicant. It is thus possible to thicken the dykes of the basic skeleton without significantly reducing the hole size.

The method advantageously also comprises a step of applying a rough surface structure to at least the active side of the stencil by means of an electrodeposition step. The deposition of the rough surface structure is more advantageous than etching with regard to costs, safety and environmental friendliness. It has been found that the etching of a basic stencil using a 10% strength solution of nitric acid at slightly elevated temperature (approximately 30° C.) does provide noticeable uniform matting, i.e. roughening, but the associated environmental costs, in particular of safety measures which have to be taken, are high. Therefore, the rough surface structure in the method according to the invention is applied by means of electrodeposition.

To produce the preferred embodiment of a metal perforating stencil according to the invention which is described above, the conditions of the method are preferably as follows:

Nickel adhesion layer: 20 Ah, thickness 1 μm

Copper roughening layer: 150 Ah, thickness 5 μm and

Nickel covering layer: 50 Ah, thickness 2 μm

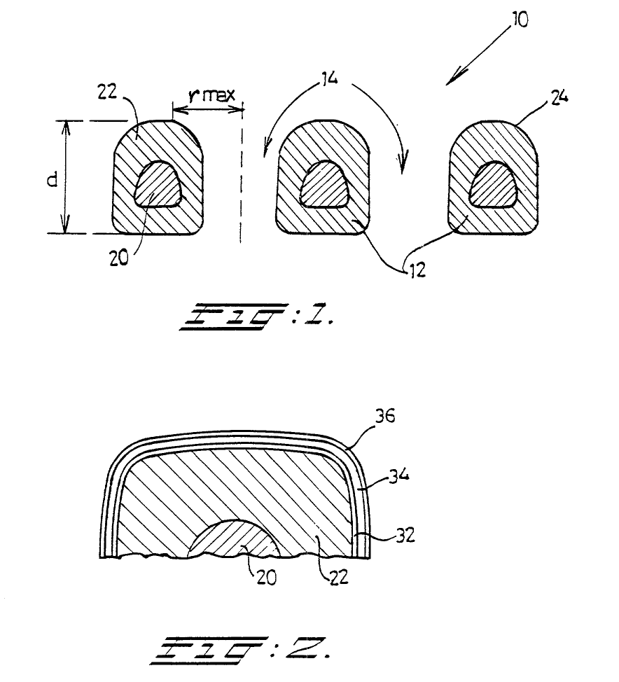

In the drawing FIG. 1 shows part of a perforating stencil 10 with dykes 12 which delimit a continuous opening 14 which, in the case illustrated, are in the form of a cylinder. The maximum radius of the opening 14 on the active side is denoted by rmax. The thickness of the stencil is d. The relationship d/rₘₐₓ>1.15 applies. This stencil 10 is produced by depositing nickel, for example from a Watt's bath, on an electroforming mould with a pattern of insulator regions, corresponding to the pattern of continuous openings 14 in stencil 10, to form a relatively thin basic skeleton 20. This basic skeleton 20 is then removed from the mould and is selectively grown in an electrodeposition bath, to which bath a brightener, as described in EP-A-0 492 731, had been added. The growth is indicated by reference numeral 22. The active side of the dykes 12 formed in this way has rounded corners 24.

FIG. 2 shows a rough surface structure 30 which has been deposited by means of electrodeposition in more detail, as explained in more detail in the examples below. This surface structure comprises a nickel adhesion layer 32, a copper roughening layer 34 and a nickel covering layer 36.

### EXAMPLE 1

Tests on a laboratory scale were carried out using pieces of 10×10 cm which had been cut out of a perforating stencil with large continuous openings. The test pieces were firstly degreased using a conventional degreasing agent and were then thoroughly rinsed, so that all residues of the degreasing agent were removed. The test pieces were then subjected to an electrodeposition treatment in a copper bath. Test piece 1 was subjected to an electrodeposition treatment in a copper bath (200 g/l CuSO₄, 70 g/l HₛSO₄, Cl⁻<15 mg/l) for one minute at 8 A/m², after which the copper-plated test piece was nickel-plated on both sides at 10 volts for 30 seconds in a nickel bath (Ni²⁻, (total) 90 g/l, H₃BO_{3 40} g/l, NiCl₂ 15 g/l). Test piece 2 was subjected to a treatment in the same copper bath for three minutes at 10 A/m². Prior to the nickel-plating step, which was carried out in the same way as for test piece 1, half the copper-plated test piece was etched using chromic acid. Test piece 3 was produced in the same way as test piece 2, including the partial etching with chromic acid, the layer of copper being applied at 20 A/m² for 30 minutes.

Although the test pieces 1 and 2 were provided with a layer of copper, they still did not have a rough surface structure. The third test piece had a uniform rough surface structure. However, the part which had been treated with chromic acid was found to be smoother than the part which had not been treated with chromic acid. Apparently, the etching using chromic acid caused the copper unevenness to become flattened.

### EXAMPLE 2

This example was carried out using a film-perforating stencil which had been produced a few weeks prior to the test. This stencil was a pentagonal 18 mesh stencil with a repeat of 162 and length of 1550 mm. The stencil was firstly degreased and rinsed with water as in Example 1. Then, a nickel adhesion layer was applied at 20 Ah at 1000 amperes in a nickel bath with a composition of 3.0 g/l Ni²⁺ (total), H₂SO₄ 325 g/l, Cl⁻≦5.0 mg/l. All the adhering nickel liquid was then rinsed off, after which the nickel-plated stencil was placed in a copper bath of the same composition as that used in Example 1. The stencil was provided with a layer of copper at 150 Ah at 1000 amperes. The stencil obtained in this way, after removal of the copper liquid by rinsing, was placed in the nickel bath which had already been used earlier, the conditions then being set to 50 Ah and 500 amperes. The above treatment resulted in a metal perforating stencil which had a surface structure which was composed of a nickel adhesion layer with a thickness of 1 μm, a copper roughening layer with a thickness of 5 μm, a copper roughening layer with a thickness of 5 μm and a nickel covering layer with a thickness of 2 μm.

The stencil produced in this way was used to perforate a thin polyethylene film which was passed over the perforating stencil in a heated state, to which stencil vacuum was applied. From this, it was found that the release of the perforated film from the stencil no longer caused any problems, while there was no excess deformation of the film and consequently no irregular perforations were formed, and also the service life of the stencil was longer than the stencils which have hitherto been customary.

The increase in the thickness of the stencil on account of the coating treatment according to the invention and the slight loss of permeability can be compensated for by allowing the basic skeleton to grow to a lower thickness, which is then subjected to the coating treatment according to the invention.

Table 1 below gives the properties of a number of stencils which have been produced in a similar way and some properties of perforated films produced therewith.

TABLE 1
Stencil

| | | | | | Ratio of |
|---|---|---|---|---|---|
| | | | | | stencil |
| | | | | | thickness |
| | | | | | to max. |
| | Penta | | Thickness | Permeability | hole |
| No | Mesh | Holes/cm² | (μₘ) | (%) | radius |
| 87 | 18 | 51 | 509 | 35.7 | 1.250 |
| 93 | 24 | 94 | 412 | 34.6 | 1.400 |
| 95 | 24 | 94 | 432 | 32.9 | 1.500 |
| 97 | 24 | 94 | 468 | 31.5 | 1.670 |
| 86 | 18 | 51 | 515 | 36.8 | 1.240 |
| 96 | 24 | 94 | 434 | 35.5 | 1.470 |

Film

| Permeability | | Strike through |
|---|---|---|
| (%) | Wetback (gr) | (sec) |
| 25 | 0.050 | 3.280 |
| 25 | 0.055 | 2.800 |
| 25 | 0.059 | 4.300 |
| 23 | 0.060 | 3.900 |
| 27 | 0.053 | 2.940 |
| 25 | 0.058 | 3.800 |

In Table 1 above, the “wetback” or “rewet” represents the flow of moisture back out of the film. The “strike through” is a measure of the absorption of the film and is measured as the time which is required to absorb a specific quantity (number of drops) of moisture.

For a very good film, the “wetback” is approximately 0.05 g and the “strike through” is 2-3.5 sec, while for a film categorized as poor these values are ≦0.5 g and ≧4 sec.

What is claimed is

1. Metal perforating stencil for use in making perforations under vacuum in a plastic film, which stencil comprises a metal cylindrical support in which there are continuous openings, which openings are separated by dykes, wherein the ratio of the thickness of the stencil to the maximum radius of a continuous opening on the active side of the stencil is more than 1.15.

2. Perforating stencil according to claim 1, wherein the stencil is seamless.

3. Perforating stencil according to claim 1, wherein at least the active side of the stencil is provided with a rough surface structure which is deposited by electrodeposition.

4. Perforating stencil according to claim 3, wherein the rough surface structure comprises a covering layer of nickel, a roughening layer of copper and an adhesion layer for promoting the adhesion of the copper roughening layer to the support.

5. Perforating stencil according to claim 4, wherein the adhesion layer consists of nickel.

6. Perforating stencil according to claim 1, wherein the dykes which delimit the openings do not have any sharp transitions on the active side of the stencil.

7. Method for producing a metal perforating stencil, which stencil comprises a support in which there are continuous openings, which openings are separated by dykes, wherein the stencil is produced in such a manner that the ratio of the thickness of the stencil to the maximum radius of a continuous opening on the active side of the stencil is more than 1.15.

8. Method according to claim 7, wherein the stencil is provided with a rough surface structure by means of an electrodeposition step.

9. Method according to claim 8, wherein the electrodeposition step comprises the partial steps of depositing a nickel adhesion layer on a metal support from an electrodeposition bath, followed by depositing a copper roughening layer from an electrodeposition bath and depositing a preferably nickel covering layer from an electrodeposition bath.

10. Method according to claim 7, comprising the steps of depositing a basic skeleton on an electroforming mould with a pattern of insulator regions which are separated by electric conductors, removing the basic skeleton from the electroforming mould and allowing the basic skeleton to grow further in a suitable electrodeposition bath, to form a stencil.

11. Use of a perforating stencil according to claim 1, for perforating of a thin plastic film under vacuum.
